(19) United States
(12) Patent Application Publication
(10) Pub. No.: US 2023/0148700 A1
(43) Pub. Date: May 18, 2023

(54) FRAME BODY FOR COSTUME, COSTUME, AND METHOD FOR MANUFACTURING THE SAME

(71) Applicant: Go Go production Co., Ltd., TOKYO (JP)

(72) Inventor: Naonori NIMURA, TOKYO (JP)

(21) Appl. No.: 17/619,802

(22) PCT Filed: Jul. 14, 2021
(86) PCT No.: PCT/JP2021/026534

§ 371 Date: Dec. 16, 2021

(30) Foreign Application Priority Data
Feb. 8, 2021 (JP) 2021-018491

(51) Int. Cl. A42C 5/04; A42C 1/00; B29C 51/28; B29C 51/10

(52) U.S. Cl. CPC A42C 5/04; A42C 1/00; B29C 51/28; B29C 51/10

(57) ABSTRACT

A frame for a lightweight costume with air permeability, the costume, and a method for manufacturing them. The frame body for the costume includes a main body made of synthetic resin and a plurality of through holes penetrating the main body. The method includes a mold installation step of installing a mold in a predetermined three-dimensional shape on an elevating table, a resin member mounting step of mounting a resin member on a pedestal, a cover mounting step of mounting a cover covering the surface of the resin member on the pedestal, a heating step of heating the resin member and the cover, a vacuum molding step of bringing the mold into contact with the back surface of the resin member and then depressurizing the inside of the chamber, and a mold release step of releasing the frame body and the cover from the mold.

### TECHNICAL FIELD

The present invention relates to a frame body for a costume, the costume, and a method for manufacturing the same.

### BACKGROUND ART

It is known that many costumes of a size allowing a human to wear inside that represent local and regional mascots, cartoon heroes, characters, and the like are manufactured by pasting cloth (namely, surface decorative materials) on the surface of a frame body that is a three-dimensional molded object. Further, a three-dimensional molded object made of synthetic resin by using a vacuum molding method and a method for manufacturing that are known.

For example, Patent Document 1 discloses a structure of a costume that can be mass-manufactured easily, quickly, and affordably in the manner that a main body of a costume (namely, three-dimensional molded object) is manufactured by creating a plane-developed paper pattern based on three-dimensional design and measurement data of the costume output from a personal computer, creating cut pieces made of resin foam or other materials according to the paper patterns, joining the cut pieces according to the output three-dimensional design, and then attaching a surface decorative material to the outer surface of the main body.

Further, for example, Patent Document 2 discloses a method for manufacturing a helmet in the manner of using a coating sheet as a patternless colored layer and a pressure-sensitive adhesive layer that are sequentially laminated for one surface of a protective sheet made of transparent or translucent thermoplastic resin, arranging the pressure-sensitive adhesive layer of the coating sheet in a vacuum molding furnace toward the outer surface of a cap body after detachably holding the cap body at the mold position in the vacuum molding furnace, depressurizing the pressure-sensitive adhesive layer side of the coating sheet while heating to be brought into close contact with the outer surface of the cap body, and trimming and removing excess parts of the coating sheet after cooling. This method enables easy finishing of the outer surface of the cap body in a short time and manufacture of the cap body having a different color and shape, as well as a different pattern and design in a wide variety and in a small lot as desired.

### RELATED ART DOCUMENTS

### Patent Documents

[Patent Document 1] Utility Model Registration Publication No. 3185651

[Patent Document 2] Japanese Unexamined Patent Publication No. 2007-100272

### DISCLOSURE OF THE INVENTION

### Problems to be Solved by the Invention

As described above, Patent Document 1 discloses a technique for creating a three-dimensional molded object for a costume from a paper pattern. And it is generally known that a frame body is made of expanded polystyrene, fiber reinforced plastic (FRP), or other materials, and a costume is created by attaching pile cloth or other materials to the frame body.

However, since such a conventional costume is worn and moved in by a human, there is a problem that the internal temperature rises, so that the human wearing the costume may suffer from heat stroke or dehydration. In particular, since styrofoam has a heat insulating property, there is a problem that the human wearing the costume is more likely to suffer from heat stroke, dehydration, and other physical difficulties. On the other hand, a three-dimensional FRP molded object has difficulty in processing (punching) so that a plurality of through holes can have regularity, causing problems of low productivity and large burden on the environment with difficulty in recycle or disposal.

In addition, there is a conventional blower-type costume sending air with an attached blower to maintain the shape of the costume under the pressure. There is also another type of costumes with a blower attached to a conventional costume. However, there have been problems such as weight of the blower applied to these types of costumes making them heavier, breakdown of the blower, and leaking noises of the attached blower possibly damaging an image (world view) represented by the costume. In particular, the blower-type costume poses a problem of deteriorating its appearance as its shape is maintained by air pressure to necessarily impose restrictions on its shape.

Further, as described above, Patent Document 2 discloses a three-dimensional molded object of a helmet manufactured by vacuum molding using an original shape (mold). However, there has been a problem that no conventional vacuum molding method can form a three-dimensional molded object having a plurality of through holes.

In view of the above circumstances, it is an object of the present invention to provide a frame body for a costume and a costume that are lightweight, easy to move in, and have high air permeability, and a method for manufacturing them.

### Means of Solving the Problems

As a result of diligent research and development on the above-mentioned problems, the inventor of the present invention has found as breakthroughs a frame body for a costume and a costume, and a method for manufacturing them, which will be described below.

A first embodiment of the present invention for solving the above problems is a frame body for a costume provided with a main body made of synthetic resin and a plurality of through holes penetrating the main body. The frame body is formed by deforming a sheet-shaped or flat-plate-shaped resin member on which the through holes are formed in advance into a predetermined shape by using a vacuum molding method.

Here, the “vacuum molding method” refers to a method for processing a sheet of thermoplastic resin or other materials, or in other word, a method for molding by cooling a heat-softened sheet or the like being left deformed by vacuum pressure.

According to this first embodiment, the plurality of the through holes formed on the frame body contribute to weight saving to provide the frame body for the costume improved in air permeability.

A second embodiment of the present invention is the frame body for the costume according to the first embodiment characterized in that the through holes are deformed in shape as compared with before the vacuum molding of the resin member.

This second embodiment can provide the frame body for the costume lighter in weight.

A third embodiment of the present invention is the frame body for the costume according to the first or second embodiment characterized in that the through holes have an enlarged area as compared with before vacuum molding of the resin member.

This third embodiment can provide the frame body for the costume much lighter in weight.

A fourth embodiment of the present invention is a costume including the frame body for the costume according to any one of the first to third embodiments and a surface decorative material attached to the surface of the frame body. The frame body is characteristically a frame body for a part of the costume covering at least a wearer's head and face.

This fourth embodiment can provide the costume that is easy for a wearer to move in due to the frame body for the costume significantly reduced in weight compared with the conventional structure, and enables the wearer to easily hear external sounds due to the plurality of the through holes formed on the frame body. In addition, the plurality of the through holes formed on the frame body contribute to high air permeability, so that the inside of the costume is less likely to become stuffy, leading to prevention of oxygen deficiency in the wear's body. This results in improvement in measures against the heat inside the costume, so that the wearer is less likely to suffer from heat stroke or dehydration. Moreover, this can prevent fogging and dew condensation on the lens corresponding to the eyes of the costume.

A fifth embodiment of the present invention is a method for manufacturing a frame body for a costume by deforming a sheet-shaped or flat plate-shaped resin member by using a vacuum molding apparatus. This method for manufacturing the frame body for the costume characteristically includes a cover mounting step of mounting a sheet-shaped cover on the resin member on which the through holes are formed in advance so as to seal at least the through holes, a heating step of heating the resin member and the cover, a vacuum molding step of bringing the mold in a predetermined three-dimensional shape into contact with the resin member on which the cover is mounted to vacuum-mold an object in the three-dimensional shape, and a mold release step of releasing the object in the three-dimensional shape from the mold.

This fifth embodiment can manufacture the frame for the costume reduced in weight, easy to move in, and with high air permeability. Further, according to this embodiment, the plurality of the through holes formed on the frame body contribute to weight saving to provide the frame body for the costume that is easy to handle. In addition, the cover mounting step can prevent air intrusion from the through holes in the vacuum molding step, thereby enabling the manufacture of the frame body for the costume having the plurality of the through holes in the vacuum molding step. This can improve the productivity of the frame body for the costume and the costume.

A sixth embodiment of the present invention is a method for manufacturing a frame body for a costume by deforming a sheet-shaped or flat-plate-shaped resin member by using a vacuum molding apparatus including a chamber, a freely elevatable elevating table housed in the chamber, a pedestal arranged on the upper part of the chamber, and a heater arranged above the pedestal. This method for manufacturing the frame body for the costume characteristically includes a mold installation step of installing a mold on the elevating table, a resin member mounting step of mounting on the pedestal the sheet-shaped or flat plate-shaped resin member on which the plurality of the through holes are formed in advance, a cover mounting step of mounting the sheet-shaped cover on the pedestal so as to seal at least the through holes on the resin member, a heating step of heating the resin member and the cover with the heater, a vacuum molding step of elevating the mold by using the elevating table to be brought into contact with the resin member and then depressurizing the inside of the chamber, a mold release step of releasing the molded resin member and the cover from the mold, and a cover detachment step of detaching the cover from the resin member.

This sixth embodiment can easily manufacture the frame body for the costume reduced in weight, easy to move in, and with high air permeability. Further, according to this embodiment, the plurality of the through holes formed on the frame body contribute to weight saving to provide the frame body for the costume that is easy to handle. In addition, the cover mounting step can prevent air from entering the chamber through the through holes, which enables the manufacture of the frame body having the plurality of the through holes in the vacuum molding step, thereby improving the productivity of the frame body for the costume.

A seventh embodiment of the present invention is the method for manufacturing the three-dimensional molded object as described in the sixth embodiment, characteristically including a mold release agent application step of applying a mold release agent to at least the surface of the mold and the surface of the resin member before or after the mold installation step.

This seventh embodiment can easily detach the resin member from the mold, thereby enabling easier manufacture of the frame for the costume reduced in weight, easy to move in, and with high air permeability.

An eighth embodiment of the present invention is the method or manufacturing the frame body for the costume as described in any one of the sixth to eighth embodiments, characteristically including a through hole forming step of forming the plurality of the through holes on the resin member before the mold installation step.

The eighth embodiment can easily manufacture the frame for the costume on which the plurality of the through holes are formed from the resin member on which no through holes are formed.

### BRIEF DESCRIPTION OF THE DRAWINGS

FIG. 1 is a perspective view showing a schematic configuration example of a frame body for a costume according to one embodiment of the present invention;

FIG. 2 shows an example of a resin member serving as a base of a frame body for a costume according to the present invention, of which FIG. 2A is a front view, and FIG. 2B is a cross-sectional view (A-A) of FIG. 2A;

FIG. 3 shows an example of a vacuum molding apparatus according to the present invention, of which FIG. 3A is a schematic view of the vacuum molding apparatus, and FIG. 3B is a schematic view of a mold, a resin member, and a cover installed in the vacuum molding apparatus;

FIG. 4 is a schematic view showing a procedure of a method for manufacturing the three-dimensional molded object of FIG. 1, of which FIG. 4A is a view showing a mold release agent application step, FIG. 4B is a view showing a mold installation step, and FIG. 4C is a view showing a preheating step;

FIG. 5 is a schematic view following FIG. 4, of which FIG. 5A is a view showing a resin member mounting step, FIG. 5B is a view showing a cover mounting step, and FIG. 5C is a view showing a resin member and cover fixing step;

FIG. 6 is a schematic view following FIG. 5, of which FIG. 6A is a view showing a heating step, and FIG. 6B is a view showing a stretching step;

FIG. 7 is a schematic view following FIG. 6, of which FIG. 7A is a view showing a vacuum molding step, FIG. 7B is a view showing a mold release step, and FIG. 7C is a view showing a cutting step;

FIGS. 8A and 8B are views showing a specific example of a frame body for a costume;

FIG. 9 is a side view showing a specific example of a frame body for a costume;

FIG. 10 is a view schematically showing a wearer of a costume wearing a frame body on his/her head; and

FIGS. 11A and 11B are graphs showing heat dissipation and moisture permeability respectively inside head parts of the present invention and a conventional head part.

### MODE FOR CARRYING OUT THE INVENTION

Hereinafter, embodiments of a frame body for a costume, a costume, and a method for manufacturing them according to the present invention will be described with reference to the accompanying drawings. It should be noted that the present invention is not limited to the following embodiments.

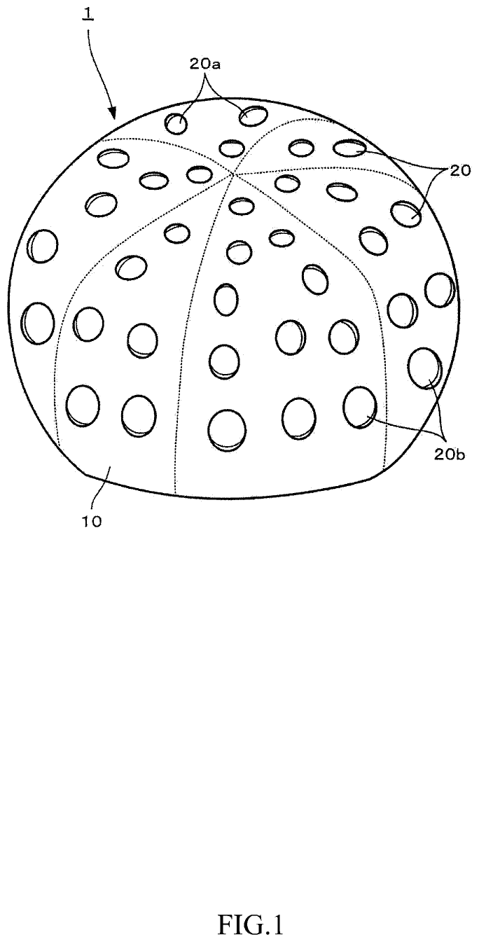

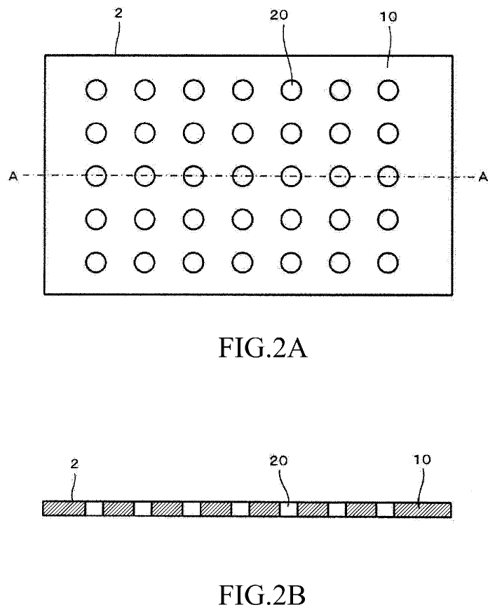

FIG. 1 is a perspective view showing a schematic configuration example of a frame body for a costume according to one embodiment of the present invention, and FIG. 2 shows an example of a resin member serving as a base of a frame body for a costume according to the present invention, of which FIG. 2A is a front view, and FIG. 2B is a cross-sectional view (A-A) of FIG. 2A. The frame body for the costume of the present embodiment will be described with reference to FIGS. 1 and 2.

The frame body 1 for the costume includes a main body 10 made of synthetic resin and a plurality of through holes 20 penetrating the main body 10. The frame body 1 is a resin member 2 heat-deformed by a vacuum molding method described later (see FIG. 1). The frame body 1 shown in FIG. 1 constitutes a frame body for a part of the costume covering a wearer's head and face (namely, body parts above his/her neck). Hereinafter, this part will be referred to as a “head part”. In addition, in FIG. 1, the through holes 20 are shown in a considerably larger size than the actual size for convenience of illustration, and accordingly the size and number of the through holes 20 are not limited to how they look in FIG. 1.

As shown in FIG. 2, the resin member 2 is in the form of a sheet or a flat plate, approximately 1 mm to 2 mm (more preferably, 1 mm or 1.5 mm) in thickness, and made of thermoplastic resin that can be deformed by heating such as ABS (acrylonitrile butadiene styrene), polyethylene, polyvinyl chloride, AS (acrylonitrile styrene) and other materials. See FIG. 2. It should be noted that neither thermoplastic resin constituting the resin member 2 nor its shape (including thickness) is particularly limited. Still, ABS is especially preferable from the viewpoint of strength, productivity, and weight reduction.

The frame body 1 is used as the frame body for the costume in the present embodiment, and the costume is eventually created by attaching cloth or the like serving as a surface decorative material to the frame body 1. By using ABS as the resin member 2, the costume becomes light, and the wearer feels cool (or in other words, the air permeability is improved, and the internal temperature is unlikely to rise). Further, a large number of the through holes 20 formed on the frame body 1 can secure the air permeability of the costume, particularly of the head part. Therefore, carbon dioxide contained in exhaled breath of the costume wearer is free from being trapped inside the costume, thereby achieving suppressing effect on the increase in concentration of carbon dioxide inside the costume even if the wearer's breathing becomes rough due to his/her performance involving vigorous movement such as dancing. Accordingly, a favorable condition can be maintained in the costume, contributing to improvement of wearer's safety and performance.

As shown in FIG. 2, the through holes 20 provided on the main body 10 can be formed in advance by punching the sheet-shaped resin member 2 before three-dimensional molding. The through holes 20 may be regularly arranged (for example, in a staggered pattern) or irregularly arranged. The through holes 20 are generally circular in shape, but may be elliptical, triangular, quadrangular, polygonal, or in another shape. Further, the through holes 20 may be same or different in size. When they are different, for example, when they are circular, they have different diameters. When they are quadrangular, they have different vertical and horizontal dimensions. In the present embodiment, the through holes 20 in circular shape having the same diameter and regularly arranged are used. Thus, by forming the plurality of the through holes 20 on the main body 10 so as to be regularly arranged and using a vacuum molding method described later, a three-dimensional molded object on which the plurality of the through holes are regularly formed can be manufactured.

The frame body 1 is molded by thermally deforming the resin member 2 by using a vacuum molding apparatus 100 that will be described later. As a result, the shape of the through hole 20 is deformed in proportion to how much the resin member 2 surrounding the through hole 20 is deformed (or in other words, the through holes 20 are also stretched in the direction in which the resin member 2 is stretched at the time of vacuum molding by using the vacuum molding apparatus). The area of the through hole 20 on the frame body 1 is enlarged compared with the area of the through hole 20 formed on the resin member 2 before deformation. Under such circumstances, the through holes include a mix of a through hole 20a less deformed and a through hole 20b greatly deformed. The difference between these through holes 20a, 20b is caused by the through holes 20 stretched in proportion to the length at which the resin member 2 is stretched at the time of vacuum molding by using the vacuum molding apparatus. Namely, the difference in the stretched length of the resin member 2 makes the mixture of the through hole 20a less deformed and the through hole 20b greatly deformed.

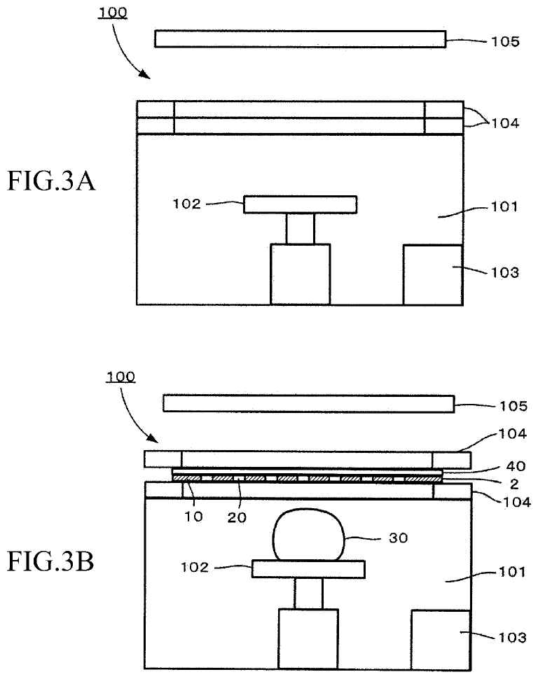

Next, the vacuum molding apparatus used for vacuum molding of the frame body 1 will be described with reference to FIG. 3. FIG. 3 shows an example of the vacuum molding apparatus, of which FIG. 3A is a schematic view of the vacuum molding apparatus, and FIG. 3B is a schematic view of the mold, the resin member, and a cover that are installed in the vacuum molding apparatus.

The vacuum molding apparatus 100 includes a chamber 101, a freely elevatable elevating table 102 for fixing the mold 30 housed in the chamber 101, a vacuum pump 103 for adjusting air pressure in the chamber 101, a pedestal 104 provided on the chamber 101 for fixing the resin member 2 and the cover 40 placed on the surface of the resin member 2, and a movable heater 105 above the pedestal 104.

The pedestal 104 is composed of two members so as to sandwich the resin member 2 and the cover 40, and both members have an opening at the center and communicate to the inside of the chamber 101. The air pressure inside the chamber 101 is adjusted by the vacuum pump 103, which is enabled by covering the opening of the pedestal 104 with the resin member 2. However, since the plurality of the through holes 20 penetrating the main body 10 are formed on the resin member 2 of the present embodiment, no air pressure inside the chamber 101 can be adjusted without the cover 40. Then, by covering the surface of the resin member 2 with the cover 40, the through holes 20 and the opening of the pedestal 104 are hermetically closed (or in other words, the through holes 20 are sealed with the cover 40), thereby enabling vacuum molding. The cover 40 may cover the surface of the resin member 2 not entirely but partially as long as it can seal at least the through holes 20 so as to adjust the air pressure inside the chamber 101.

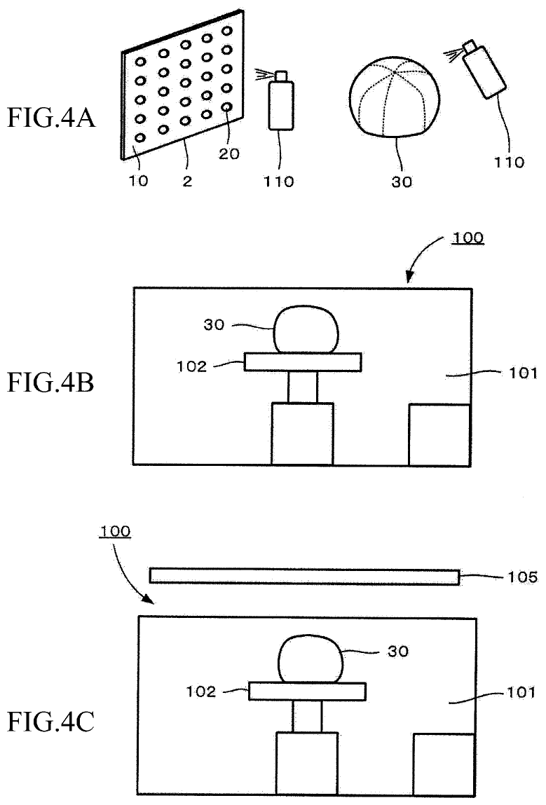

Moreover, in the following, an example of a manufacturing method procedure for molding the frame body 1 from the resin member 2 by using the vacuum molding apparatus 100 will be described with reference to FIGS. 4 to 7. It should be noted that FIGS. 4 to 7 show only what is essential for the steps.

### <Mold Release Agent Application Step: FIG. 4A>

First, a mold release agent is applied to the surface of the mold 30 in a predetermined three-dimensional shape with a spray can 110 or the like so that the resin member 2 can be easily detached (separated) from the mold 30. Further, the mold release agent is applied to the surface of the resin member 2 with the spray can 110 or the like so that the cover 40 can be easily detached from the resin member 2. The mold release agent to be applied (sprayed) is not particularly limited, but an aqueous vinyl-based mold release agent containing polyvinyl alcohol, water, ethyl acetate, and alcohol solvent may be used. Alternatively, a mold release agent made of silicon, petrolatum or other materials may be used.

The above-mentioned the mold release agent application step may be performed at least to the front surface of the mold 30 and the front surface of the resin member 2, but may be performed to the back surface of the resin member 2 and the back surface of the cover 40. The mold release agent may be applied to the mold 30 before or after a mold installation step that will be described later, and the mold release agent may be applied to the resin member 2 after a resin member mounting step that will be described later. Namely, the mold release agent application step can be changed in order according to the steps.

### <Mold Installation Step: FIG. 4B>

The mold 30 molded into a predetermined three-dimensional shape of wood, FRP, styrofoam, etc. and serving as the basis of the shape of the frame body 1 is installed on the elevating table 102.

### <Preheating Step: FIG. 4C>

After that, the mold 30 is preheated. When preheating the mold 30, the inside of the chamber 101 may be preheated concurrently. The preheating may be performed by using the heater 105 used in a heating step that will be described later, or an alternative for the heater 105 may be provided separately. The preheating of the mold 30 can prevent the resin member 2 from being cooled by the mold 30 when the mold 30 and the resin member 2 come into contact with each other in a vacuum molding step that will be described later.

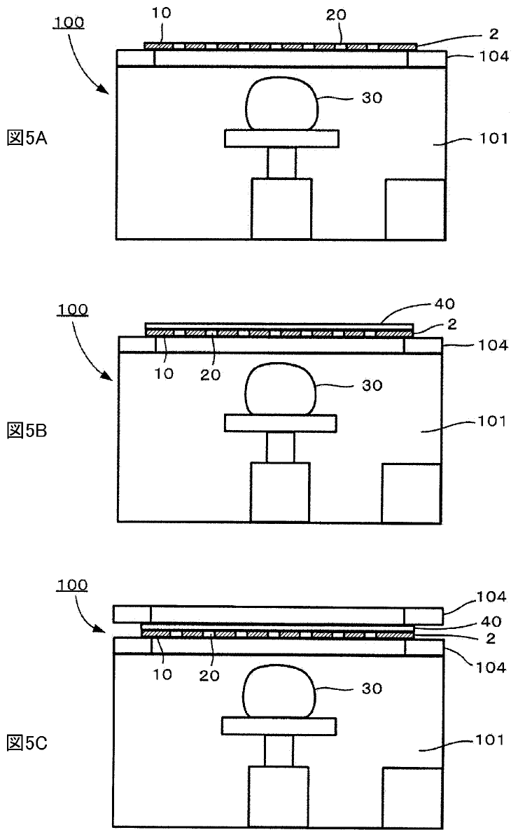

### <Resin Member Mounting Step: FIG. 5A>

A peripheral edge of the resin member 2 is mounted on the pedestal 104.

### <Cover Mounting Step (Seat Cover Mounting Step): FIG. 5B>

The peripheral edge of the cover 40 is mounted on the pedestal 104 so as to cover the entire surface of the resin member 2. Accordingly, the through holes 20 on the resin member 2 are sealed by the cover 40 to prevent air outside and inside the chamber 101 from entering and exiting through the through holes 20. It should be noted that as far as vacuum molding can be carried through in the vacuum molding step that will be described later, the cover 40 does not have to cover the entire surface of the resin member 2, and may cover only a part thereof. That is, it is desirable that the cover 40 is placed on the resin member 2 so as to seal at least the through holes 20.

### <Resin Member and Cover Fixing Step: FIG. 5C>

The resin member 2 and the cover 40 are fixed to the pedestal 104. The fixing method is not particularly limited, but examples thereof may include sandwiching the peripheral edges of the resin member 2 and the peripheral edges of the cover 40 between the two pedestals 104. The present embodiment employs the fixing method for sandwiching between the two pedestals 104. When the resin member 2 is mounted on the pedestal 104, the upper part of the mold 30 may be in contact with a part of the back surface of the resin member 2.

The cover 40 has a sheet shape similar to the resin member 2. Materials thereof are not particularly limited, but any resin having better heat softness and better compatibility with the resin member 2 in terms of molding shrinkage rate is selected. For example, if the resin member 2 is ABS, soft vinyl chloride (soft PVC) or another material is selected for the cover 40. The cover 40 is preferably approximately 0.3 mm to 0.8 mm in thickness. Still, the thickness may be appropriately changed depending on the shape (size, roughness, etc.) of the mold 30 and on the material of the resin member 2. It should be noted that by using the cover 40 made of soft vinyl chloride, as will be described later, even when the cover 40 is detached from the surface of the frame body 2 after molding while being pulled with a relatively strong force, the cover 40 can be detached without being torn. This can facilitate the detachment step for the cover 40 and timesaving.

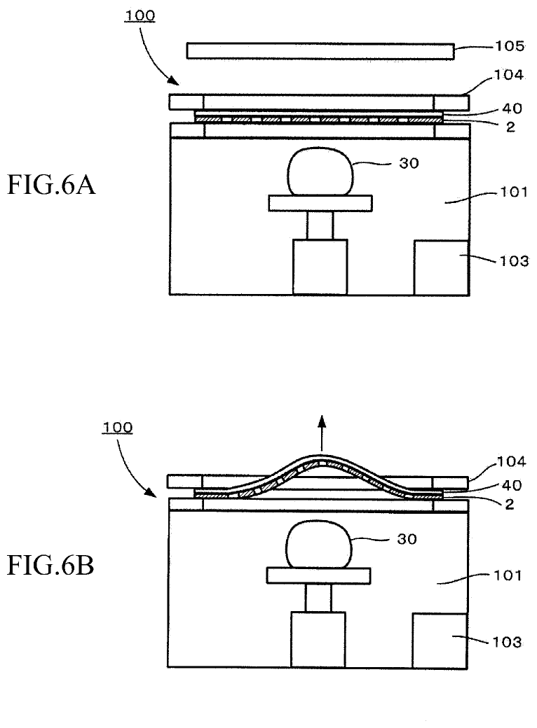

### <Heating Step: FIG. 6A>

After fixing the resin member 2 and the cover 40 to the pedestal 104, the heater 105 is operated to heat the resin member 2 and the cover 40. As the temperature rises due to heating, the resin member 2 and the cover 40 are thermally deformed downward in the center due to their own weight. Then, after a lapse of a predetermined time, the heating of the heater 105 is stopped, and the heater 105 is distanced from the resin member 2 and the cover 40.

### <Stretching Step: FIG. 6B>

When the resin member 2 and the cover 40 are heated, they hang downward. Under such circumstances, in order to prevent them from hanging downward, the vacuum pump 103 is operated to pressurize the inside of the chamber 101 and then stretch (inflate) the resin member 2 and the cover 40 upward. See the arrow direction in FIG. 6B. After that, it is preferable to elevate the mold 30 to be further stretched to a position where the upper part of the mold 30 and the back surface of the resin member 2 come into contact with each other.

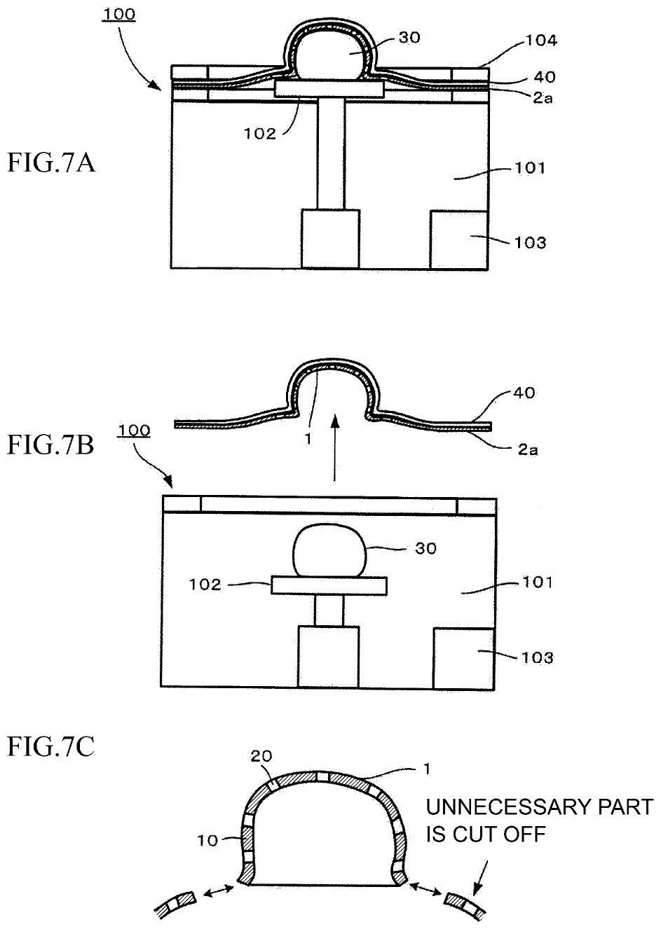

### <Vacuum Molding Step: FIG. 7A>

The elevating table 102 is elevated by an air cylinder or the like, and the mold 30 is concurrently elevated to bring the resin member 2 and the mold 30 into contact with each other. Further, it is desirable that the mold 30 protrudes above the mounting surface of the resin member 2. After that, the vacuum pump 103 is operated to discharge the air inside the chamber 101 to reduce the pressure to below atmospheric pressure. Then, as the pressure is reduced, space between the front surface of the mold 30 and the back surface of the resin member 2 turns into a vacuum, whereby the resin member 2 and the cover 40 are closely deformed along the surface shape of the mold 30. It should be noted that the elevation of the elevating table 102 and depressurization is performed concurrently.

Here, because of the plurality of the through holes 20 formed on the resin member 2, the resin member 2 can be more easily deformed to be fit to the shape of the mold 30 as compared with the case where no through holes 20 are formed. Moreover, the vacuum molding method contributes to improvement in productivity. It should be noted that while the through holes 20 are deformed in the heating step, the stretching step, and the vacuum molding step, the vacuum molding step achieves the largest deformation amount.

### <Mold Release Step: FIG. 7B>

After returning the pressure inside the chamber 101 to the atmospheric pressure and allowing it to cool, the deformed resin member 2a and the deformed cover 40 are removed from the mold 30. In the description of the present embodiment, since the resin member 2 is described as being in the form of a sheet, the resin member 2 after vacuum molding is referred to as the “deformed resin member 2a” in accordance with the actual situation. However, this is not a closed term. Further, in FIG. 7B, the mold 30 returns into the chamber 101 as the elevating table 102 is lowered. Still, depending on the shape of the mold 30, it can be removed from the vacuum molding apparatus 100 together with the resin member 2.

### <Cutting Step: FIG. 7C>

Next, the cover 40 is detached from the resin member 2a. The cover 40 is detached from the surface of the resin member 2a by picking and pulling the end part of the cover 40 with a finger or the like. At this time, if the cover 40 is made of soft vinyl chloride, the cover 40 is remarkably untearable even if it is pulled strongly, which facilitates detachment. Further, the mold release agent applied to the surface of the resin member 2a also makes an effect of easy detachment of the cover 40. In this connection, the aqueous vinyl-based mold release agent mentioned above as the mold release agent enables the cover 40 to be more easily detached.

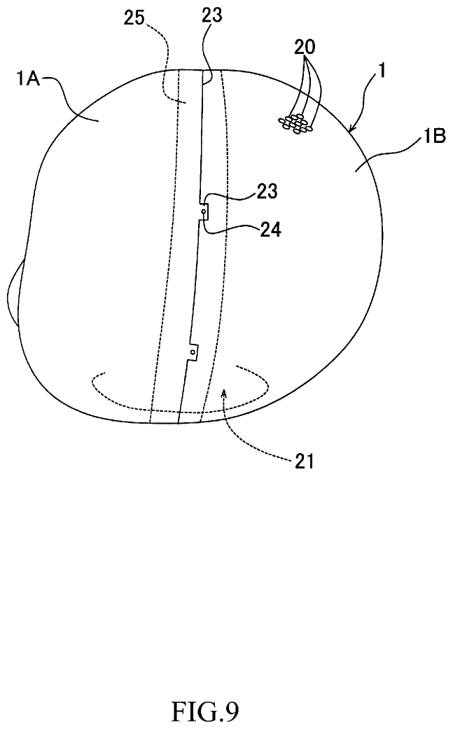

After the cover 40 is detached from the resin member 2a, the unnecessary part of the deformed resin member 2a is cut off with a cutter or other tools to bring the frame body 1 to completion. Depending on the shape of the mold 30, the deformed resin member 2a may be unable to be removed from the mold 30. In that case, the deformed resin member 2a can be divided into a plurality of parts to be removed from the mold 30. And, it is possible to bring the frame body 1 to completion by joining (sticking, welding, riveting, etc.) the parts divided into plurality. As a method for joining the plurality of the parts, FIG. 9 and a related method that will be described later can be given as an example. Further, when no cutting step is required, the deformed resin member itself 2a in the mold release step serves as the frame body 1.

In addition to the above-mentioned steps, a through hole forming step for forming on the resin member 2 the plurality of the through-holes 20 penetrating the main body 10 of the resin member 2 may be provided before the mold installation step.

Through the above-described steps, the frame body 1 can be molded from the sheet-shaped resin member 2. While all the steps have been described for the sake of detail, some of them are essential, and the others are selectively introduced. These steps can be also changed in the order as appropriate.

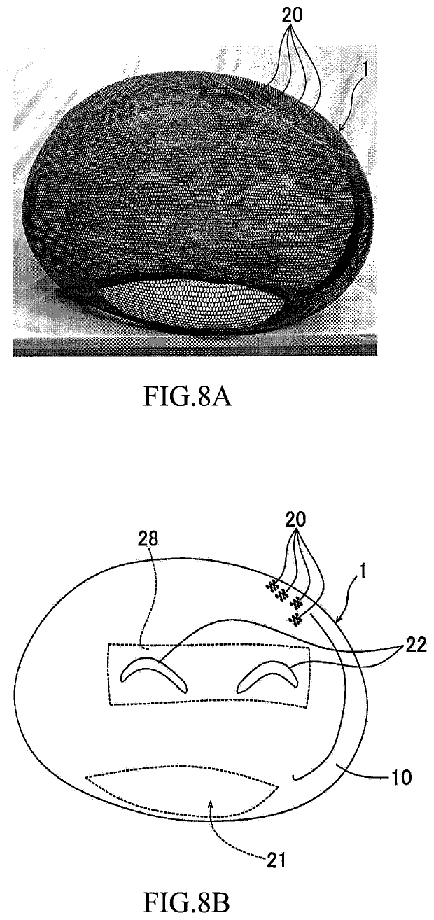

Next, a procedure for manufacturing the head part of the costume using the frame body 1 formed in the above-described steps will be described. FIGS. 8A and 8B are front views showing a specific example of the frame body 1 for the costume, of which FIG. 8A is a schematic view showing a real photograph of the frame body 1, and FIG. 8B is a schematic view of the photograph in FIG. 8A. It should be noted that although only some of the through holes 20 on the frame body 1 (main body 10) are shown in FIG. 8B and FIGS. 9 and 10 that will be described later, the through holes 20 are actually provided on the entire frame body 1 (main body 10) as shown in FIG. 8A.

The frame body 1 shown in FIGS. 8 and 9 is provided with a large number of the through holes 20 on the entire main body 1, a lower opening 21 for a wearer to put on his/her head formed at a lower end of the main body 1, and a pair of front openings 22, 22 corresponding to the eyes of the costume formed on the front surface of the main body 1. Further, as shown in FIG. 9, the frame body 1 is formed by integrally joining two parts, one of which is a front part 1A constituting a substantially front half and the other of which is a rear part 1B constituting a substantially rear half. The front part 1A and the rear part 1B are joined at a substantially linear boundary line 23 extending from the upper end of the frame body 1 through both side surfaces to the lower end. Overlapping parts 23a of the front part 1A and the rear part 1B provided at a plurality of locations along the boundary line 2 are joined by a joining tool 24 such as a rivet, and a strip-shaped joining sheet 25 is glued on the boundary line of the inner surface side of the frame body 1. This enables the front and rear parts 1A, 1B to be joined on the boundary line 23 without a gap. It should be noted that examples of the joining sheet 25 may include a sheet made of ABS resin or other materials, but not limited to this.

Further, as shown in FIG. 8B, around the pair of the front openings 22, 22 corresponding to both eyes on the inner surface of the frame body 1, a visibility securing sheet 28 is attached for sealing the through holes 20 to secure satisfactory visibility of the wearer. Materials for the visibility securing sheet 28 are not particularly limited as far as they prevent light incident from the through holes 20 around the front openings 22, 22 from being transmitted, but a dark color hard to transmit light is preferable. By attaching the visibility securing sheet 28 to a predetermined range around the front openings 22, 22, no light incident from the through holes 20 into the frame body 1 enters the wearer's field of view. Thus, the wearer is at no risk of feeling flickering or glare in his/her eyes.

Further, an edge part 21a of the lower opening 21 shown in FIG. 9 is to be held by the wearer with his/her hand when he/she puts on the head part, which requires strength enough to withstand repeated use. For that purpose, in the present embodiment, as shown in the same figure, a reinforcing member 29 made of a strip-shaped sheet is attached to the edge part 21a of the lower opening 21. The reinforcing member 29 is attached to the front and back surfaces of the edge part 21a and its vicinity so as to cover the edge part 21a. This reinforcing member 29 can secure the strength of the edge part 21a of the lower opening 21. It should be noted that the material for the reinforcing member 29 may be a sheet made of ABS resin or the like, but not limited to this as long as required strength and durability can be secured.

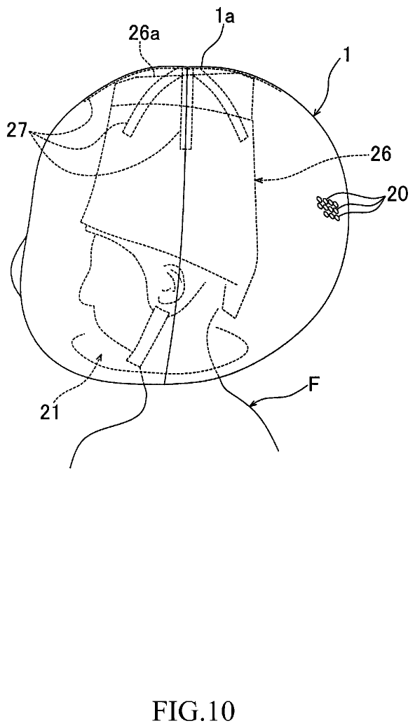

FIG. 10 is a view schematically showing how the wearer of the costume wears the frame body 1 on his/her head. While no surface decorative materials attached to the surface of the frame body 1 are shown in FIG. 10 for convenience of explanation, any surface decorative materials are attached to the surface of the frame body 1 when the wearer actually wears the head part as a part of the costume. As shown in FIG. 10, a headpiece-shaped fitting 26 worn by the wearer F over his/her head is attached to the inside of the frame 1. An upper end part 26a of the fitting 26 is fixed to the inner surface of a ceiling part 1a of the frame body 1. In this configuration, since the ceiling part 1a of the frame body 1 is mounted on the upper end part 26a of the fitting 26, a load due to the weight of the frame body 1 is applied to the ceiling part 1a of the frame body 1. Therefore, it is desirable to reinforce the ceiling part 1a of the frame body 1. As a configuration for reinforcement, in the present embodiment, as shown in FIG. 10, a plurality of reinforcing members 27 are attached to the inner surface of the ceiling part 1a of the frame body 1. The reinforcing member 27 is a strip-shaped and sheet-shaped member made of ABS resin or other materials, and a plurality of the reinforcing members 27 are radially attached around the apex of the ceiling part la. These reinforcing members 27 can secure the strength of the ceiling part 1a of the frame body 1. It should be noted that the above-mentioned material for the reinforcing member 27 and the above-mentioned method for attaching the reinforcing member 27 are merely examples, and thus other embodiments may be applied.

Moreover, although not shown in the figure, an air permeable surface decorative member such as pile-woven fabric is installed (attached) to the surface of the frame body 1. The pile-woven fabric here refers to fabric whose pile is woven on one side or both sides of knitted fabric by plain weave or twill weave. It should be noted that the surface decorative material is not limited to the pile-woven fabric, and may have other configurations as long as the surface thereof is brushed like fur (so-called “bore”). Moreover, the surface decorative material is not limited to the one with a brushed surface, and thus may be a non-brushed cloth material, a sheet material, or other materials.

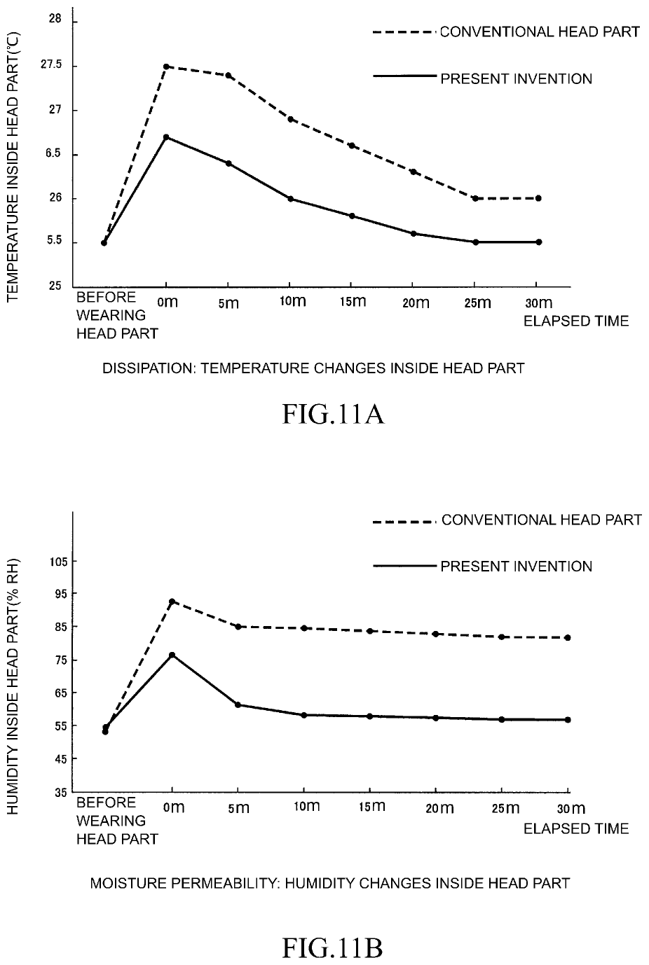

Here, a test example regarding heat dissipation and moisture permeability inside the head part of the costume (completed by attaching the surface decorative material) manufactured following the above-described procedure will be described. FIGS. 11A and 11B are graphs showing the heat dissipation and moisture permeability of the inside of the head part provided with the frame body 1 made of ABS having the through holes 20 of the present embodiment (hereinafter, referred to as “head part of the present invention”) and a head part provided with a frame body made of FRP without air permeability nor through holes of the conventional configuration (hereinafter, referred to as “conventional head part”). The graph in FIG. 11A shows temperature changes inside the head part of the present invention (solid line) and the conventional head part (dotted line), and the graph in FIG. 11B shows humidity changes inside the head part of the present invention (solid line) and the conventional head part (dotted line). It should be noted that these graphs show the results of measured temperature and humidity before wearing the costume (before wearing the head part) and measured temperature and humidity for each elapsed time in the case where the costume is taken off after wearing for 20 minutes and left in a state where the lower opening 21 of the head part is sealed.

As shown in the graph of FIG. 11A, with respect to the temperature before wearing the costume, the temperature inside the head part of the present invention immediately after wearing for 20 minutes (elapsed time: 0 minutes) is significantly lower than the temperature inside the conventional head part. Further, the temperature inside the head part of the present invention is lower than the temperature inside the conventional head part at each elapsed time after wearing. And, while the temperature inside the head part of the present invention 25 minutes after wearing has dropped to the temperature before wearing (room temperature), the temperature inside the conventional head part even 30 minutes after wearing is still higher than the temperature before wearing (room temperature).

Moreover, as shown in the graph of FIG. 11B, with respect to the humidity before wearing the costume, the humidity inside the head part of the present invention immediately after wearing the costume for 20 minutes (elapsed time: 0 minutes) is significantly lower than humidity inside the conventional head part. Further, the humidity inside the head part of the present invention is lower than the humidity inside the conventional head part at each elapsed time after wearing. And, while the humidity inside the head part of the present invention has significantly dropped 5 minutes after wearing, the humidity inside the conventional head part is still as high as 80% even 30 minutes after wearing.

Moreover, the frame body made of ABS 1 having the through holes 20 of the present embodiment is reduced in weight by approximately 40% as compared with the conventional frame body made of FRP having no through holes. Further, in the conventional head part, the internal sound volume is reduced from the external sound volume by approximately 18%, whereas in the head part of the present invention, the internal sound volume is reduced from the external sound volume by approximately 6%. Therefore, the head part of the present invention is remarkably superior in voice transmission as compared with the conventional head part.

As described above, the head part of the present invention has the effect of significantly lowering the internal temperature and humidity as compared with the conventional head part. Further, the head part of the present invention is significantly lighter in weight and superior in sound transmission as compared with the conventional head part. Therefore, by wearing the head part (or, the costume provided with the head part composed of the frame body 1 having the through holes 20) of the present invention, not only measures can be taken against heat stroke of the wearer, but also significant improvement in his/her performance can be achieved.

As described above, the frame body 1 for the costume of the present embodiment includes the main body 10 made of synthetic resin and the plurality of the through holes 20 penetrating the main body 10, and the frame body 1 is formed by deforming the sheet-shaped or flat-plate-shaped resin member 2 on which the through holes 20 are formed in advance into a predetermined shape by using the vacuum molding method.

As a result, the plurality of (or, a number of) the through holes 20 formed on the frame body 1 for the costume can achieve the weight reduction of the costume provided with the frame body 1 and improve the air permeability thereof. Therefore, the costume provided with the frame body 1 having remarkably high air permeability due to the through holes 20 makes the inside of the costume hard to become stuffy, leads to prevention of oxygen deficiency of the wearer, improves heat countermeasures, makes the wearer less likely to suffer from heat stroke or dehydration, and significantly improves the performance of a performer, who is the wearer. In addition, the through holes 20 contribute to reduction in weight, enabling the wearer to easily move in and well hear external sounds. Furthermore, the through holes 20 enable prevention of fogging and dew condensation on the lens corresponding to the eyes of the costume.

In general, a costume is manufactured to order based upon predetermined designs, shapes, dimensions, etc. Accordingly, a frame body in a same shape is rarely mass-produced, and thus high-mix low-volume production or one-of-a-kind production is rather prevalent. Therefore, if a frame body having of a same shape is mass-produced by metallic molding or in other manners, the frame body having a plurality of through holes can be easily manufactured, but in reality, no manufacturing method as such can be adopted. Then, in the conventional method for manufacturing a frame body for a costume, there has been no other means for manufacturing a frame body provided with a plurality of through holes than to form the plurality of the through holes later on the frame body molded into a desired shape in advance. However, it is extremely difficult to perform the work of forming the plurality (or, a number) of the through holes on the frame body after molding because the frame body after molding has a three-dimensional and complicated shape. This work takes a lot of time and effort and also bears a risk of reducing the strength of the frame and unexpected damage. Therefore, this manufacturing method cannot be practically adopted.

On the other hand, as a result of repeated experiments and trial production related to the manufacture of a frame body for a costume, the inventor of the present application has achieved successful deformation of a sheet-shaped resin member having a plurality of through holes formed in advance into a predetermined shape by using a vacuum molding method. And, the same inventor has achieved a method for manufacturing a frame body for a costume according to the present invention including as the key requirement, the manufacture of a frame body for a costume by applying this technique. According to the method for manufacturing the frame for the costume according to the present invention, in the high-mix low-volume production or one-of-a-kind costume of the frame for the costume, even the frame body having a large number of through holes can be efficiently manufactured in a relatively short time with less burden. This enables the manufacture of the frame body for the costume excellent in air permeability and lightweight, which was practically impossible in the past.

As one embodiment of the frame body 1 of the present invention, for example, the through hole 20 is deformed in shape as compared with before vacuum molding, thereby improving flexibility and facilitating handling. Further, the through hole 20 has an enlarged area as compared with before vacuum molding, thereby achieving more reduction in weight and improving air permeability.

Moreover, one embodiment of the costume of the present invention includes the frame body 1 for the costume according to any one of the above-described first to third embodiments and the surface decorative material attached to the surface of the frame body 1. The frame body 1 is the frame body for a part of the costume covering at least a wearer's head and face.

Moreover, the method for manufacturing the frame body for the costume of the present invention is the method for manufacturing the frame body 1 by deforming the sheet-shaped resin member 2 by using the vacuum molding apparatus 100 provided with the chamber 101, the freely elevatable elevating table 102 housed in the chamber 101, the pedestal 104 arranged on the upper part of the chamber 101, and the heater 105 arranged above the pedestal 104. This method includes the mold installation step of installing the mold 30 on the elevating table 102, the resin member mounting step of mounting on the pedestal 104 the sheet-shaped or flat plate-shaped resin member 2 on which the plurality of the through holes 20 are formed in advance, the cover mounting step of mounting the sheet-shaped cover 40 on the pedestal 104 so as to seal at least the through holes 20 on the resin member 2, the heating step of heating the resin member 2 and the cover 40 with the heater 105, the vacuum molding step of elevating the mold 30 by using the elevating table 102 to be brought into contact with the back surface of the resin member 2 and then depressurizing the inside of the chamber 101, the mold release step of releasing the molded resin member 2 and the molded cover 40 from the mold 30, and the cover detachment step of detaching the cover 40 from the resin member 2.

Thus, the plurality of the through holes formed on the frame body 1 contribute to weight saving and can provide the frame body 1 for the costume that is easy to handle. In addition, the vacuum molding method improves productivity. Further, the cover mounting step can prevent air from entering the chamber 101 through the through holes 20.

As one embodiment of the method for manufacturing the frame for the costume of the present invention, for example, the method includes the mold release agent application step of applying the mold release agent at least to the surface of the mold 30 and the surface of the resin member 2 before or after the mold installation step. This enables easy detachment of the deformed resin member 2a in close contact with the mold 30 from the mold 30 and easy detachment of the cover 40 in close contact with the deformed resin member 2a from the frame body 1, so that the workability of the mold release step is improved.

As one embodiment of the method for manufacturing the frame body for the costume of the present invention, for example, the method includes the preheating step of preheating at least the mold 30 after the mold setting step. This can prevent the resin member 2 in contact with the mold 30 from being cooled.

As one embodiment of the method for manufacturing the frame for the costume of the present invention, for example, the method includes the stretching step of stretching the resin member 2 and the cover 40 upward after the heating step. This inflates upward the resin member 2 and the cover 40 that have hung downward in the preheating step, and accordingly can prevent the resin member 2 and the cover 40 from hanging downward.

As one embodiment of the method for manufacturing the frame body for the costume of the present invention, for example, the method includes after the mold release step, the cutting step of cutting off an unnecessary part of the resin member 2. As a result, the frame body 1 is brought to completion.

As one embodiment of the method for manufacturing the frame body for the costume of the present invention, for example, the method includes before the mold installation step, the through hole forming step of forming the plurality of the through holes 20 on the resin member 2. This can achieve in-house production of forming the through holes 20, leading to cost reduction.

Although the embodiments of the present invention have been described above, the present invention is not limited to the above-described embodiments, and can be appropriately modified, improved, and the like. In addition, the materials, shapes, sizes, numerical values, forms, numbers, arrangement locations, etc. of each component in the above-described embodiments are optional and are not limited as long as the present invention can be achieved.

In the above-described embodiments, the mold release agent is applied to the surface of the mold and the surface of the resin member 2. However, the present invention is not limited to this, and thus no mold release agent necessarily has to be applied to these surfaces.

Further, in the above embodiments, the frame body 1 for the costume according to the present invention has been described as the frame body for the part of the costume covering the wearer's head and face (namely, the body parts above his/her neck) of the costume. Still, the frame body for the costume according to the present invention may be used as a frame body for other parts of the costume. For example, the frame body 1 may be not only for the part of the costume covering the wearer's head and face (the body parts above his/her neck), but also for parts of the costume covering his/her chest, entire upper body, and other body parts.

### INDUSTRIAL APPLICABILITY

The frame for the costume, the costume and the method for manufacturing the same of the present invention are most suitable for the field where a lightweight and highly air-permeable costume is desired.

1. A frame body for a costume, the frame body comprising:
a main body made of synthetic resin; and
a plurality of through holes penetrating the main body,
wherein the frame body is formed by deforming a sheet-shaped or flat-plate-shaped resin member on which the through holes are formed in advance into a predetermined shape by using a vacuum molding method.

2. The frame body for the costume according to the claim 1, wherein the through holes are deformed in shape as compared with before vacuum molding of the resin member.

3. The frame body for the costume according to claim 1, wherein the through holes have an enlarged area as compared with before vacuum molding of the resin member.

4. A costume comprising:
the frame body for the costume according to any one of claim 1; and
a surface decorative material attached to a surface of the frame body,
wherein the frame body is a frame body for a part of the costume, the part covering at least a wearer's head and face.

5. A method for manufacturing a frame for a costume from a sheet-shaped or flat-plate-shaped resin member by deforming the resin member by using a vacuum molding apparatus,
wherein the method includes:
a cover mounting step of mounting a sheet-shaped cover on the resin member on which a through hole is formed in advance so as to seal at least the through hole;
a heating step of heating the resin member and the cover;
a vacuum molding step of bringing a mold in a predetermined three-dimensional shape into contact with the resin member on which the cover is mounted to vacuum-mold an object in the three-dimensional shape; and
a mold release step of releasing the three-dimensional object from the mold.

6. A method for manufacturing a frame for a costume by deforming a sheet-shaped resin member by using a vacuum molding apparatus comprising:
a chamber; an elevating table housed in the chamber;
a pedestal arranged on an upper part of the chamber; and
a heater arranged above the pedestal,
wherein the method includes:
a mold installation step of installing a mold in a predetermined three-dimensional shape on the elevating table;
a resin member mounting step of mounting on the pedestal the sheet-shaped or flat-plate-shaped resin member on which a plurality of through holes are formed in advance;
a cover mounting step of mounting a sheet-shaped cover on the pedestal so as to seal at least the through hole on the resin member;
a heating step of heating the resin member and the cover with the heater;
a vacuum molding step of elevating the mold by using the elevating table to be brought in contact with the resin member and depressurizing the inside of the chamber;
a mold release step of releasing the molded resin member and the molded cover from the mold; and
the cover detachment step of detaching the cover 40 from the resin member.

7. The method for manufacturing the frame body for the costume according to claim 6, wherein the method includes a mold release agent application step of applying a mold release agent at least to a surface of the mold and a surface of the resin member before or after the mold installation step.

8. The method for manufacturing the frame body for the costume according to claim 6, wherein the method includes a through hole forming step of forming the plurality of the through holes on the resin member before the mold installation step.
